(19) United States
(12) Patent Application Publication
(10) Pub. No.: US 2017/0209993 A1
(43) Pub. Date: Jul. 27, 2017

(54) TORQUE WRENCH

(71) Applicant: Norbar Torque Tools Ltd, Banbury, Oxfordshire (GB)

(72) Inventor: Richard Owen, Banbury, Oxfordshire (GB)

(21) Appl. No.: 15/327,797

(22) PCT Filed: Jul. 20, 2015
(86) PCT No.: PCT/GB2015/052093

§ 371 Date: Jan. 20, 2017

(30) Foreign Application Priority Data
Jul. 21, 2014 (GB) 1412881.3

(51) Int. Cl. B25B 23/142

(52) U.S. Cl. CPC B25B 23/1427

(57) ABSTRACT

A breaking torque wrench (2) comprises a head portion 8 pivotally connected to a main tubular body (4) and a breaking mechanism (10) comprising a first part (22) and a second part (24) which have a movable point of mutual contact, wherein the first part (22) is connected to the head portion 8 and the second part 24 is resiliently urged into contact with the first part (22), such that when the torque wrench (2) is used to apply a predetermined torque, the first part (22) moves relative to the second part (25), allowing the head portion (8) to pivot about the main tubular body (4) of the torque wrench and the second part 24 to move relative to the main tubular body (4).

This invention relates to breaking torque wrenches.

Breaking torque wrenches use an angular break in the motion of the torque wrench to minimise the chances of over-tightening a work piece. This is because when the set torque has been reached, part of the torque wrench body moves through an angle relative to the rest of the body, providing a clear indication to the user.

In prior art wrenches the break is achieved by the head piece of the torque wrench pivoting about the main body as a cam surface moves against a fixed reaction plate. During this motion the connecting rod, to which the head piece of the torque wrench is attached, typically slides out of the main body of the wrench to facilitate the pivoting motion of the head piece and the movement of the cam surface. The Applicant has appreciated that this introduces a potential pinch point between the connection rod and the main body of the wrench. In addition, in order for the wrench to break, the adjustment mechanism disposed at the opposite end of the wrench, near to where a user grips the wrench, moves into the main body of the wrench. The Applicant has further appreciated that this introduces a potential drag point where the adjustment mechanism moves into the main body. Both the pinch point and drag point introduce a potential risk that a user may get their skin or clothing caught in the device causing injury.

Furthermore the Applicant has appreciated that in prior art wrenches in order to increase the tension on the spring, an adjustment nut is typically screwed onto the connection rod, the nut compressing the spring. The implication of this, which the Applicant has appreciated, is that if the threaded connection should fail when the spring is under tension, there is a possibility that the adjustment nut would be caused to shoot out away from the tool. As wrenches of the kind described above are typically used for larger torques, the tension on the spring can be significant and as a result such a failure resulting from a poor manufacturing quality would risk causing a serious injury.

Furthermore prior art breaking torque wrenches tend to have a broad break point. This slow breaking motion can cause a user to apply an inaccurate amount of torque. This is because a user can feel the wrench start to break, which begins to happen before the actual set point, and may interpret this as the set torque having been applied. As the set torque is not applied until the tool fully breaks, this pre-emptive stopping of torque application causes an under-tightening of a work piece.

In order to prevent this under-tightening, it has been proposed to alter the cam plate within the breaking mechanism, which moves against a reaction plate in order to provide the breaking motion. By changing the cam plate such that it has a more severe profile, the angle through which the torque wrench body moves during breaking is reduced. This gives a slower break point. However, it increases the ‘free’ movement of the tool once the cam plate has slipped past the break point. This slipping could be dangerous as the motion of the torque wrench is uncontrolled.

The present invention aims to address the issues discussed above and when viewed from a first aspect provides a breaking torque wrench comprising a head portion pivotally connected to a main tubular body and a breaking mechanism comprising a first part and a second part which have a movable point of mutual contact, wherein the first part is connected to the head portion and the second part is resiliently urged into contact with the first part, such that when the torque wrench is used to apply a predetermined torque, the first part moves relative to the second part, allowing the head portion to pivot about the main tubular body of the torque wrench and the second part to slide relative to the main tubular body.

Thus it can be seen by those skilled in the art that a pinch point between the head portion and main body may be eliminated as the head portion is pivotally connected to the main body instead of being pivotally connected to a connection rod. By reversing the breaking mechanism such that the second part is urged into contact with the first part, and allowing the second part to move relative to the main tubular body, removes the requirement of the head portion moving axially relative to the main tubular body. This therefore increases the safety of operation of such torque wrenches.

The breaking torque wrench may comprise any suitable arrangement for urging the second part into contact with the first part. In a preferred set of embodiments the second part is urged by a resilient member, e.g. a spring. The spring or other member may be chosen depending on the application of the breaking torque wrench and the torque range required.

It will be appreciated that the force applied to the second part to resiliently urge it into contact with the first part, e.g. the force applied by the resilient member, determines the breaking torque of the wrench. In a preferred set of embodiments the wrench comprises an adjustment mechanism for adjusting the compression of the resilient member. In a set of embodiments the adjustment mechanism comprise an adjustment screw which moves axially within the main tubular body and acts to compress the resilient member. In a set of such embodiments the adjustment screw acts on one end of the resilient member and the other end of the resilient member acts on the second part to urge it into contact with the first part.

In a set of embodiments when the breaking torque wrench reaches breaking torque, the adjustment screw does not move relative to the main tubular body. In a set of embodiments a pin is provided to retain the adjustment screw in case of failure. In such an arrangement where the resilient member comprises a spring, the position of the spring may be effectively fixed at the end of the body where the adjustment mechanism is. This may be advantageous as typically the adjustment mechanism is positioned near to where the user grips and applies force to the torque wrench. Therefore as the spring position is fixed at this end by the adjustment mechanism and free to move axially at the opposite end where it is in contact with the second part, which means that the adjustment mechanism does not slide into the main body and therefore there is no drag point in which the user's skin could get caught.

In one set of embodiments the second part moves internally within the main tubular body of the wrench. In an alternative set of embodiments the second part moves externally of the main tubular body.

In a set of embodiments the second part comprises a sleeve which surrounds the main body. Such an embodiment is advantageous as the movement of the second part corresponds to movement of a sleeve around the main body, this mechanism has no dangerous pinch points.

In a set of embodiments the first part comprises a cam plate. In a set of such embodiments the cam plate is pivotally connected to the head portion. In an alternative set of embodiments the first part comprises a roller.

In a set of embodiments the second part comprises a reaction plate. In a set of embodiments the second part is arranged to move axially along the main tubular body.

Preferably the torque wrench is made of metal, preferably steel. Preferably the torque wrench has a maximum torque setting greater than 100 Nm.

In a set of embodiments the profile of the cam plate and/or the profile of the reaction plate is chosen such that a clear break point is established. This is advantageous as it immediately shows the user that the breaking torque has been reached and thus prevents over-tightening of the object.

In a set of embodiments the torque wrench comprises a breaking mechanism, wherein said breaking mechanism comprises two surfaces which have a movable point of mutual contact, wherein at least one of the two surfaces comprises a first section and a second section which having a discontinuity in gradient therebetween, wherein the movable point of mutual contact:
is on the first section at an applied torque which is lower than the breaking torque of the torque wrench;
is aligned with the discontinuity in gradient at the breaking torque; and
is on the second section after the torque wrench has reached the breaking torque,
such that the two surfaces remain in contact after the breaking torque has been reached, causing a controlled break of the torque wrench.

This is novel and inventive in its own right and thus when viewed from a second aspect the invention provides a breaking torque wrench comprising a breaking mechanism, wherein said breaking mechanism comprises two surfaces which have a movable point of mutual contact, wherein at least one of the two surfaces comprises a first section and a second section which having a discontinuity in gradient therebetween, wherein the movable point of mutual contact:
is on the first section at an applied torque which is lower than the breaking torque of the torque wrench;
is aligned with the discontinuity in gradient at the breaking torque; and
is on the second section after the torque wrench has reached the breaking torque,
such that the two surfaces remain in contact after the breaking torque has been reached, causing a controlled break of the torque wrench.

Thus it can be seen that a more precise breaking point is produced, due to the introduction of a transition point where the point of mutual contact aligns with the discontinuity in gradient. The discontinuity in gradient gives the peak torque a more defined position, as it is a maximum point which must be pushed past. As torque is applied to the torque wrench, the point of mutual contact moves from the outermost point towards the body of the wrench. When this aligns with the discontinuity in gradient, the wrench can suddenly undergo a breaking movement. This provides a well-defined breaking torque, without introducing the possibility of slipping. This well-defined breaking point provides a desired torque profile. By using two surfaces with a point of mutual contact, the breaking is controlled in such a way that an operator will not be thrown off balance as the tool breaks. This increases the safety of operation of such torque wrenches.

There may be one discontinuity in the surface(s), or alternatively there may be a plurality of discontinuities. The discontinuities may be such that the risk of the first and second surfaces slipping relative to one another is minimised.

The discontinuity may be provided in either of the surfaces, or in both of the surfaces. In a set of embodiments, the two surfaces are formed by a moving surface and a static surface. In a set of such embodiments, the discontinuity is on the moving surface. Additionally or alternatively, the discontinuity or a further discontinuity may be on the static surface.

In a set of embodiments, the two surfaces are provided by a rolling cam plate and a reaction plate. The two interact to form the point of mutual contact. In a set of embodiments, the discontinuity is on the moving cam plate. As the cam plate rotates about a pivot point, the point of mutual contact moves along both the cam plate and the reaction plate. When it reaches the discontinuity in the cam plate, there is a sudden breaking. The torque wrench then fully undergoes the breaking motion, as a pre-set torque is reached. The cam plate may comprise a positioning groove, and the torque wrench may comprise a position-limiting rod. The position-limiting rod and the positioning groove may interact in order to assist control of the breaking movement.

In addition or alternatively, the discontinuity is on the reaction plate. There may be a single discontinuity, or there may be a plurality of discontinuities. This may for example be used to produce a torque profile in which there is a breaking torque, and then a stopping point.

In a set of embodiments, one of the surfaces is provided by a roller. In a set of embodiments, said roller has a constant radius. A roller may be used in combination with a reaction plate which comprises a discontinuity. In a set of embodiments, said discontinuity is used to form a pocket in which the roller may be held. The breaking torque may then occur as the roller is forced from the pocket, and moves toward the wrench body.

In a set of embodiments, the breaking torque wrench comprises at least one of: a body; a driving head; a handle; a lever arm; a shell, in which the breaking mechanism is contained; an adjustment element for altering the applied torque; and an elastic element for use within the adjustment element, wherein the adjustment element is used to adjust the elastic force applied by the elastic element.

A number of embodiments of the present invention will now be described, by way of example only, with reference to the accompanying drawings in which:

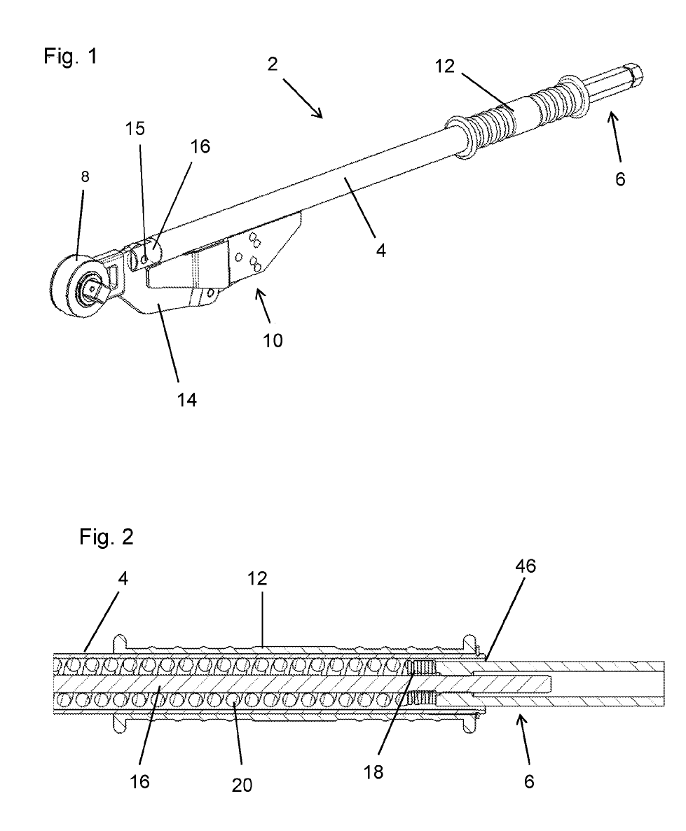

FIG. 1 shows a breaking torque wrench embodying an aspect of the invention;

FIG. 2 is partial cross-section through the wrench of FIG. 1;

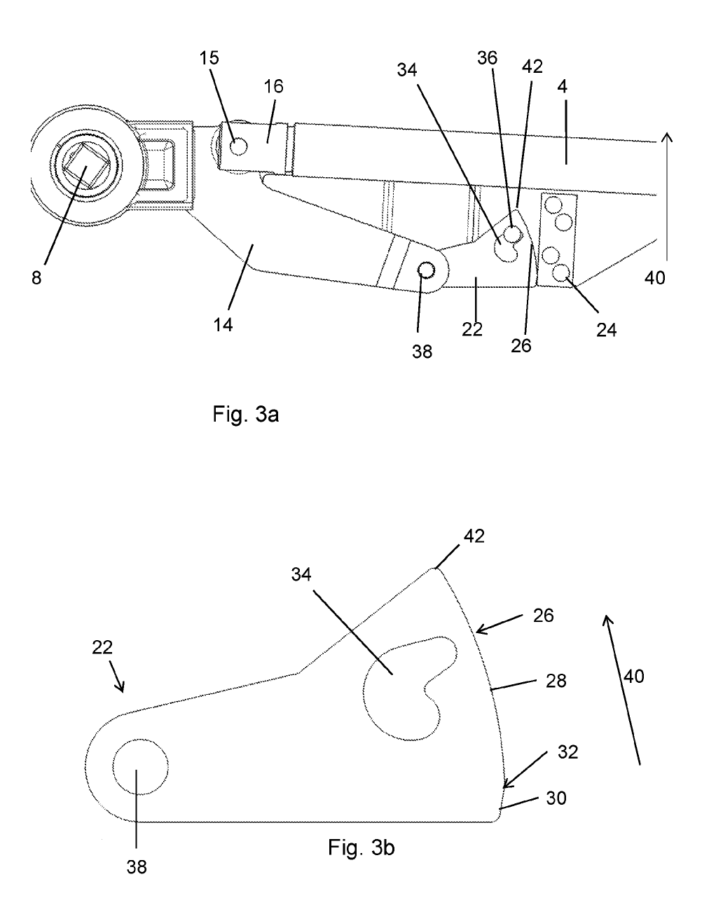

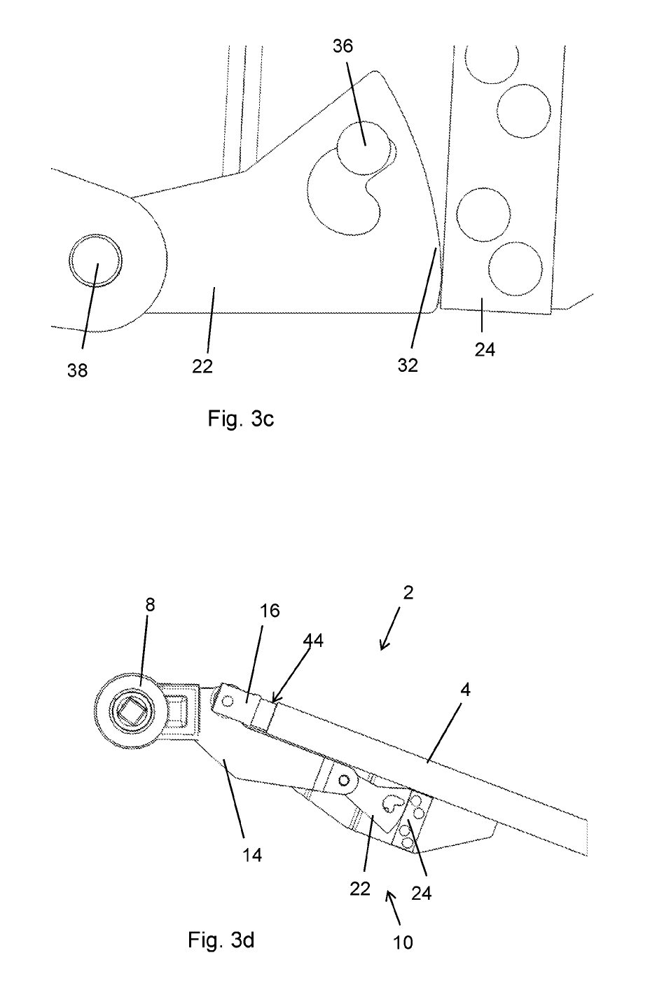

FIG. 3a is a close up view of the breaking mechanism;

FIG. 3b is a detailed view of the cam plate;

FIG. 3c is further detailed view of the cam plate in operation;

FIG. 3d is a view of the wrench once it has broken;

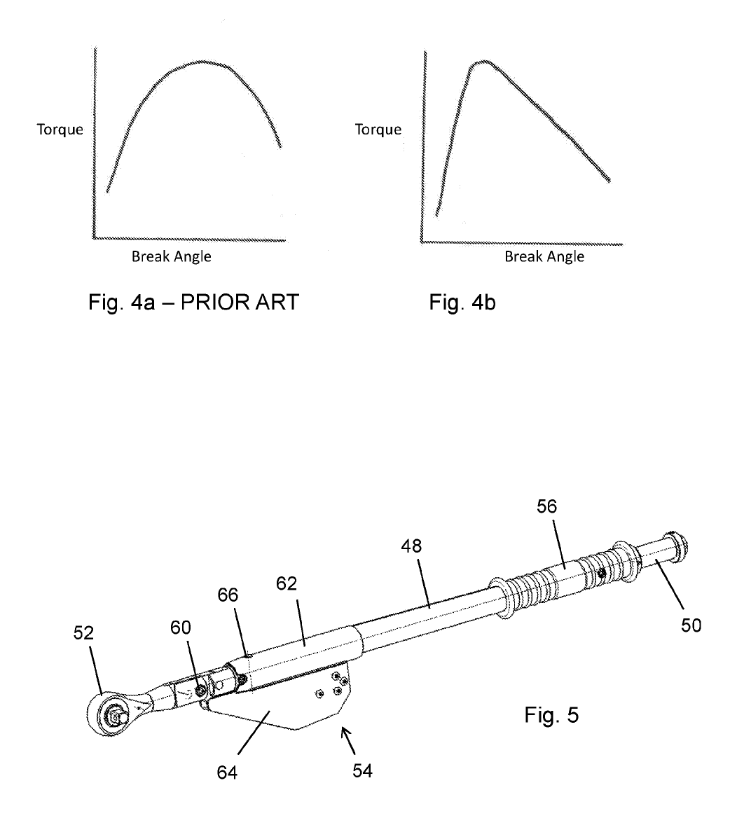

FIG. 4a shows a torque profile of a prior art torque wrench;

FIG. 4b shows an exemplary torque profile of a torque wrench in accordance with an aspect of the invention;

FIG. 5 shows a second embodiment of the invention;

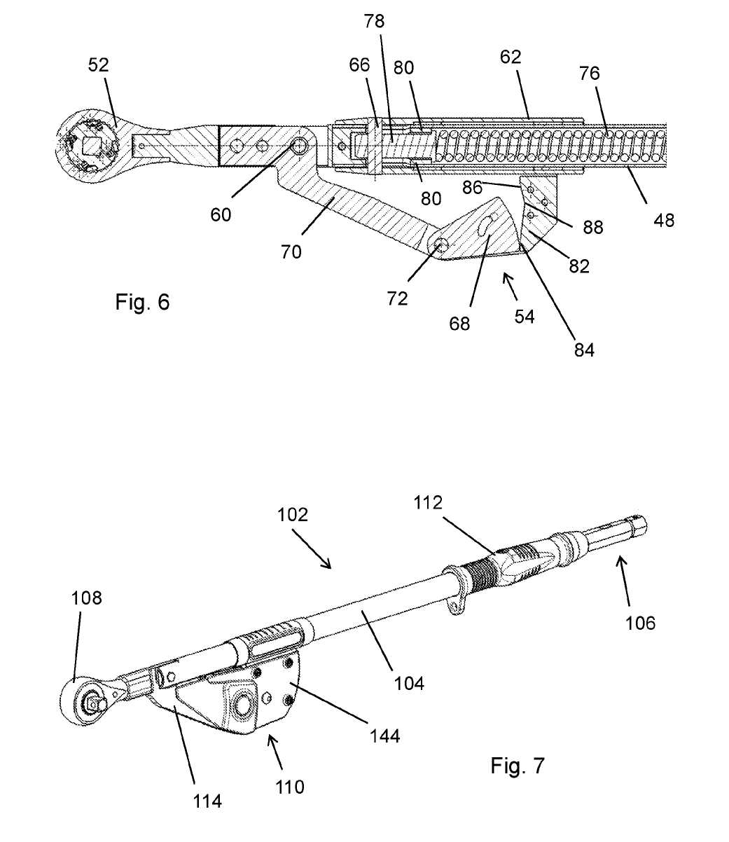

FIG. 6 is partial cross-section through the wrench of FIG. 5;

FIG. 7 shows a third embodiment of the invention;

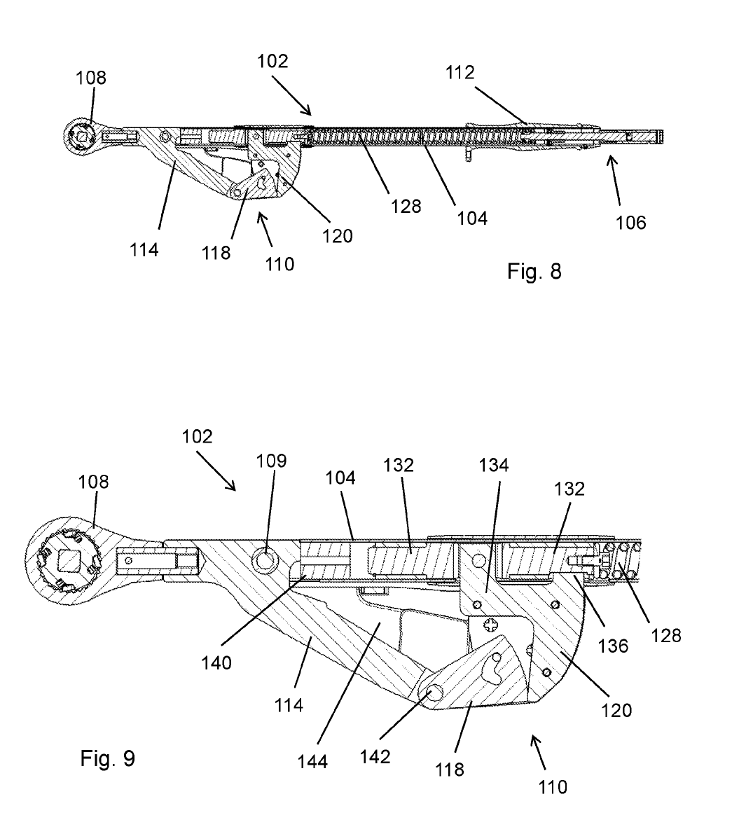

FIG. 8 is cross-section through the wrench of FIG. 7;

FIG. 9 is more detailed partial cross-section through the wrench of FIG. 7;

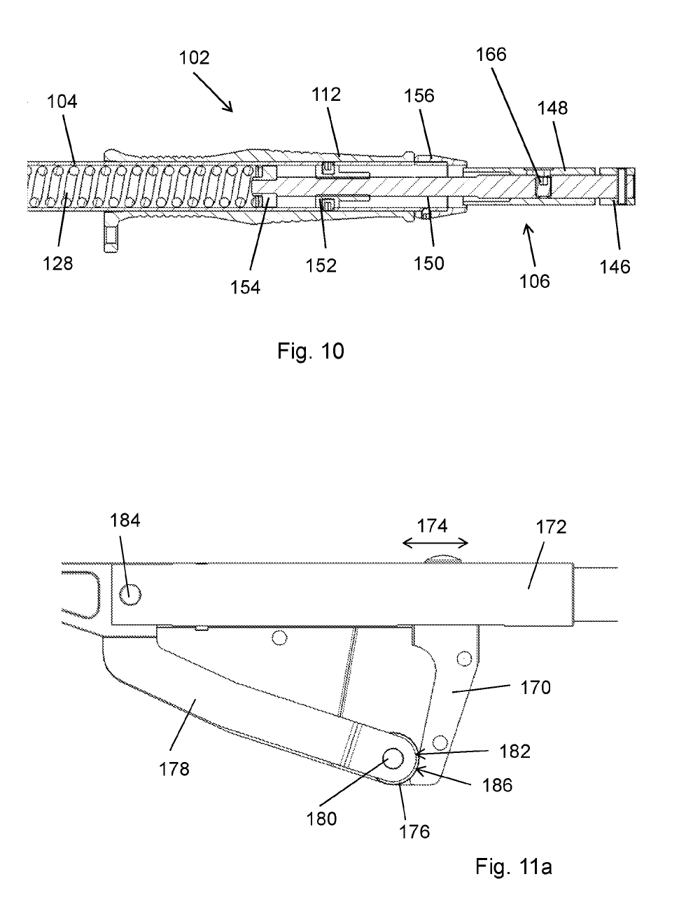

FIG. 10 is another more partial cross-section through the rear part of the wrench of FIG. 7; and

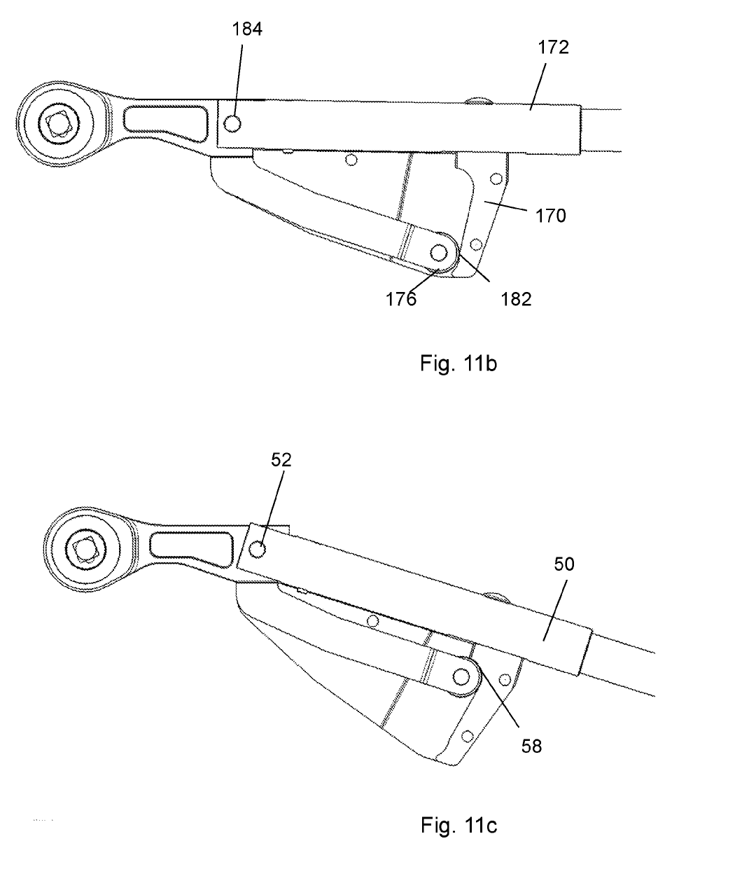

FIGS. 11a to 11c show a fourth embodiment of the invention in which a roller is used in combination with a reaction plate having a discontinuity in gradient, demonstrating the different stages of use.

FIG. 1 shows a torque wrench 2 embodying one aspect of the present invention. The torque wrench 2 comprises a main body 4, a torque setting knob 6, a head piece 8, a breaking mechanism 10 and a hand grip portion 12. The head piece 8 is connected to the breaking mechanism 10 by a branch arm 14.

As may be seen with additional reference to FIG. 2, the head piece 8 is connected by a pivot 15 to a connection rod 16, which is connected to the torque setting adjustment knob 6 by a threaded connection 18. The connection rod 16 is able to move axially within the main tubular body 4 against the compressive force of a spring 20. The knob 6 protrudes from the rear end of the main body 4 and can be twisted by a user to vary the torque setting. A scale (not shown) is provided on the knob 6 to allow the user to determine the current setting. The torque setting markings give the corresponding torque value in appropriate units (for example Newton·metres and/or Pounds force·feet). Rotating the knob 6 relative to the main body 4 causes the spring 20 to be compressed by differing amounts. This alters the resistance to movement, in particular the resistance to breaking of the torque wrench as will be explained further below.

FIGS. 3a to 3d show more detail of the breaking mechanism 10. This comprises a cam plate 22 and a reaction plate 24. The end surface 26 of the cam plate 22 comprises two sections with first and second gradients 28, 30 which meet at a discontinuity 32. The cam plate 22 has a positioning groove 34, through which a position-limiting pin 36 projects, in order to limit the movement of the cam plate 22.

The cam plate 22 is pivotally attached to the branch arm 14 of the torque wrench by a pivot point 38. The reaction plate 24 is fixed to the main body 4. The compressive force of the spring 20 selected by the user therefore determines the force with which the cam plate 22 and reaction plate 24 are urged together.

In use, the user selects a pre-set torque using the adjustment knob 6 (FIGS. 1 and 2). The torque wrench is initially in an unbroken position as shown in FIGS. 3a and 3c. The end surface 26 of the cam plate 22 is in contact with the reaction plate 24 at a point with the first gradient 30, forming a point of mutual contact.

As the user applies a torque to the torque wrench body 4, the cam plate 22 rotates about the pivot point 38. This rotation causes the point of mutual contact to move in the direction shown by the arrow 40, towards the main body 4. As the torque increases, the point of mutual contact will move closer to the discontinuity 32. When the torque set by the user is reached, the point of mutual contact will align with the discontinuity 32 (FIG. 3c). Any further application of torque will cause the point of mutual contact to move past the discontinuity 32, and the torque wrench will ‘break’, with the branch arm 14 rotating about the rotation point 15 as the cam plate 22 rotates about its pivot point 38. The point of mutual contact will move along the second gradient 28 until the corner 42 is in contact with the reaction plate 24 (FIG. 3d). The user will clearly be able to feel this sudden breaking and will thus know when to stop applying torque.

As can be seen in FIG. 3d, when the torque wrench 2 reaches its breaking torque, the end of the connection rod 16 slides out of the main body 4. The gap 44 that is created is a potential pinch point which could trap skin or clothing when the torque is released. Similarly at the other end of the wrench (see FIG. 2), the adjustment knob 6 slides into the main body 4. This introduces a drag point 46 where skin or clothes could become snagged.

FIG. 4a shows a typical torque profile for a prior art wrench whereas FIG. 4b shows a comparative profile for the torque wrench described above. The torque profile shows the relationship between torque and break angle. As may be seen the torque profile in FIG. 4b has a defined peak. There is therefore a clear point at which the correct amount of torque has been applied to cause a breaking motion of the wrench. By contrast the prior art torque profile of FIG. 4a exhibits a smooth curve, with a relatively broad peak. There is therefore an extended region over which what is felt by the user does not change much. As a result, the user may notice that the tool is beginning to break and stop applying torque to the work piece too soon. This would therefore result in the work piece being under-tightened, and potentially unsafe.

FIGS. 5 and 6 show an embodiment of both aspects of the invention. Similarly to the previous embodiment, the torque wrench comprises a main body 48, a torque setting adjustment knob 50, a head piece 52, a breaking mechanism 54 and a hand grip portion 56. The head piece 52 is pivotally connected to the main body 48 by a pivot pin 60. This embodiment, however, also comprises a sleeve 62 and a casing 64. The sleeve 62 is fixed to the breaking mechanism 54, which will be further explained below. The sleeve 62 is slidingly engaged with the main body 48 via a pin 66 which is able to move in a corresponding slot (not shown) in the main body 48. The casing 64 covers the breaking mechanism 54. This helps to protect the user from the breaking mechanism 54. Additionally the casing 64 acts to retain any part of the breaking mechanism 54 which had failed and become loose, thereby keeping it safe.

FIG. 6 shows the breaking mechanism 54 in more detail. This includes a cam plate 68 pivotally connected to a lever arm 70 at a first pivot point 72. The main body 48 is pivotally connected to a second pivot point 60, with the first and second pivot points 72, 60 being at opposite ends of the lever arm 70. The lever arm 70 is fixed to the head piece 52.

The main body 48 houses the spring 76, which is held between the torque setting adjustment knob 50 (FIG. 5) and a plunger 78 and is used to alter the force applied to the breaking mechanism 54. The spring 76 is surrounded by an external sliding sleeve 62 which can move relative to the torque wrench body 48 as previously explained. The external sliding sleeve 62 engages with the body 48 by means of the pin 66, which also passes through the plunger 78. This helps to prevent the plunger 78 and the external sliding sleeve 62 from moving past a limit generated using stop blocks 80. In this embodiment the cam plate 68 has a constant radius, and therefore a constant gradient. However, the reaction plate 82 has a section of first gradient 84 and a section of second gradient 86, which meet at a discontinuity 88.

The reaction plate 82 is directly connected to the sleeve 62. The spring 76 acts on the plunger 78 which acts on the pin 66. The pin 66 thus transfers the force provided by the spring to the sleeve 62 and hence to the reaction plate 82, thereby urging it into contact with the cam plate 68.

In use, as before, the user initially sets a target torque using the knob 50. This causes the compression on the spring 76 between the plunger 78 and the knob 60 to be altered. When the user pushes down on the main body 48, torque is applied to the head piece 52. The second pivot point 60 allows the main body 48 to rotate relative to the lever arm 70 as the torque applied increases. The cam plate 68 pivots about the first pivot point 72, causing the point of mutual contact to move along the reaction plate 82.

As the torque applied increases, the point of mutual contact moves from the section of first gradient 84, reaching the discontinuity 88 at the target torque. At this point, the torque wrench breaks, causing the wrench handle to rotate about the pivot point 74. The point of mutual contact then moves past the discontinuity 88, and onto the section of second gradient 86. This second gradient is used to prevent the tool from being over-tightened, as is provides resistance to the cam plate moving freely. As the cam plate 68 rotates about the first pivot point 72, it pushes on the reaction plate 82. The reaction plate 82 is attached to the external sliding sleeve 62, which moves relative to the main body 48 as a force is applied by the cam plate 68.

It will be appreciated that in contrast to the previous embodiment, the sliding sleeve 62 means that there is no potential pinch point near the head piece, nor a potential drag point near the handle grip. This embodiment may therefore reduce the risk of injury.

FIG. 7 shows another embodiment of the present invention which comprises a breaking mechanism that slides internally within the main body which eliminates any pinch or drag points. The torque wrench 102 comprises a main body 104, an adjustment mechanism 106, a head piece 108, a breaking mechanism 110 and a hand grip portion 112. The head piece 108 is connected to the breaking mechanism 110 by a lever arm 114. The head piece 108 is pivotally connected directly to the main body 104 at a pivot point 109.

FIG. 8 shows a sectional view of the torque wrench 102 of FIG. 7. Here it can be seen that the breaking mechanism 110 comprises a cam plate 118 and a moveable reaction plate 120. It can also be seen that a spring 128 is positioned between the cam plate 120 and the adjustment knob 106.

FIG. 9 shows a sectional view of the torque wrench 102 focussing on the breaking mechanism 110 and head piece 108 of the torque wrench 102. It can be seen in this Figure that the head piece 108 is directly pivotally connected to the main body 104. Also visible is the sliding shuttle spring compressor 132 to which an extension 134 of the reaction plate 120 is fixed. This extension projects through a suitable slot in the main body 104. The shuttle 132 is acted on by the spring 128 and thus acts to transfer the force of the spring to the reaction plate 120. Its maximum forward movement is limited by a stop member 140.

The cam plate 118 is pivotally connected about a pivot point 142 to the lever arm 114 which is fixed to the head piece 108.

During typical operation a user adjusts the tension on the spring 128 to the desired torque level using the knob 106. The spring 128 then acts to force the reaction plate 120 against the cam plate 118. As the user applies a torque using the torque wrench 102 and it reaches the breaking torque, the cam plate 118 moves relative to the reaction plate 120. As the head piece 108 is fixed axially relative to the main body 104, in order to allow this motion the reaction plate 120 slides relative to the main body 104. As the reaction plate 120 is shielded by in use by cover plates 144 on either side, the user is protected from moving parts.

FIG. 10 shows a sectional view of the adjustment mechanism 106 of the torque wrench 102. As previously described, the breaking torque is controlled by the load on the spring 128. This can be increased or decreased through compression or expansion of the spring. The adjustment mechanism comprises an adjuster nut 146, an adjustable scale 148, an adjuster screw 150, a fixed threaded insert 152 and a spring compressor 154. Also visible is a handle retainer 156 which holds the hand grip portion 112 in place. The adjuster nut 146 is directly connected to the adjuster screw 150 which is externally threaded (not shown) and passes through the fixed threaded insert 152. On the end of the adjuster screw 150 a spring compressor 154 is fixed via a push fit. The spring compressor 154 is present so that the force applied by the adjustment screw 152 acts to compress the spring 128 in a single direction so as not to cause distortion.

The fixed threaded insert 152 means that in this wrench design when a breaking torque is reached the adjustment mechanism 106 does not move relative to the main body 104 of the torque wrench 102. This therefore eliminates the drag point previously discussed. During operation the user rotates the adjuster nut 146 which causes the adjuster screw 150 to screw through the fixed threaded insert 152. This causes the spring 128 to be compress or expand.

In addition to removing the pinch point this design has further advantages. The spring compressor 154 can be designed such that even if the fixed threaded insert 152 or the thread on the adjuster screw 150 fails, then it is retained within the torque wrench rather than being dangerously ejected by the typically high compressive force on the spring.

FIG. 10 also shows how the adjustment mechanism 106 can be calibrated. The zero position of the adjustment mechanism can be calibrated by adding more or fewer washers in front of the adjuster nut 146. The adjustment mechanism 106 also comprises a clamp screw 166. The adjustable scale can be slid to the correct calibrated position and then clamped into position by the clamp screw 166.

FIGS. 11a to 11c show a further embodiment of the invention. In common with the previous embodiment this one also has the reaction plate 170 able to slide axially relative to the main body as indicated by the arrow 174.

Here rather than a rotating cam plate, a roller 176 is attached to a lever arm 178 at a rotation point 180. The reaction plate 170 has a discontinuity 182. The main body 172 is attached to the lever arm 178 at the other end by a pivot point 184. As mentioned, the reaction plate 170 is slidably attached to the torque wrench body 172, in order to allow the torque wrench body 172 to move relative to the roller 176 and lever arm 178 in the direction shown by the arrow 174.

In use, the roller 176 is initially ‘parked’ in a pocket 186 in the surface of the reaction plate 170 (see FIG. 11a). The edge of the pocket 186 is defined by the discontinuity 182, at which the breaking torque occurs. The point of mutual contact between the roller 176 and the reaction plate 170 is in the pocket 186 while the torque applied by a user to the main body 172 is less than the breaking torque.

When the applied torque reaches the breaking torque, the point of mutual contact between the roller 176 and the reaction plate 170 is at the discontinuity 182 (see FIG. 11b). At this stage, the torque wrench body 172 is beginning to rotate about the pivot point 184. Once the breaking torque has been reached, any attempt to apply further torque will cause the roller to move fully along the reaction plate 170, and to reach a stopping point 188 (FIG. 11c). During this motion, the torque wrench body 172 rotates about the pivot point 184, so that the user can clearly tell the torque wrench has broken. The stopping point 170 acts as an end stop for the roller 176.

1. A breaking torque wrench comprising a head portion pivotally connected to a main tubular body and a breaking mechanism comprising a first part and a second part which have a movable point of mutual contact, wherein the first part is connected to the head portion and the second part is resiliently urged into contact with the first part, such that when the breaking torque wrench is used to apply a predetermined torque, the first part moves relative to the second part, allowing the head portion to pivot about the main tubular body of the breaking torque wrench and the second part to slide relative to the main tubular body.

2. The breaking torque wrench as claimed in claim 1 wherein the second part is urged by a resilient member.

3. The breaking torque wrench as claimed in claim 2 comprising an adjustment mechanism for adjusting a compression of the resilient member.

4. The breaking torque wrench as claimed in claim 3 wherein the adjustment mechanism comprises an adjustment screw which moves axially within the main tubular body and acts to compress the resilient member.

5. The breaking torque wrench as claimed in claim 4 wherein the adjustment screw acts on one end of the resilient member and another end of the resilient member acts on the second part to urge the second part into contact with the first part.

6. The breaking torque wrench as claimed in claim 4 wherein when the breaking torque wrench reaches the predetermined torque, the adjustment screw does not move relative to the main tubular body.

7. The breaking torque wrench as claimed in claim 4 comprising a pin to retain the adjustment screw in case of failure.

8. The breaking torque wrench as claimed in claim 1 wherein the second part moves internally within the main tubular body.

9. The breaking torque wrench as claimed in claim 1 wherein the second part moves externally to the main tubular body.

10. The breaking torque wrench as claimed in claim 9 wherein the second part comprises a sleeve which surrounds the main tubular body.

11. The breaking torque wrench as claimed in claim 1 wherein the first part comprises a cam plate.

12. The breaking torque wrench as claimed in claim 11 wherein the cam plate is pivotally connected to the head portion.

13. The breaking torque wrench as claimed in claim 1 wherein the first part comprises a roller.

14. The breaking torque wrench as claimed in claim 1 wherein the second part comprises a reaction plate.

15. The breaking torque wrench as claimed in claim 1 wherein the second part is arranged to move axially along the main tubular body.

16. The breaking torque wrench as claimed in claim 1 wherein said breaking mechanism comprises two surfaces which have a movable point of mutual contact, wherein at least one of the two surfaces comprises a first section and a second section having a discontinuity in gradient therebetween, wherein the movable point of mutual contact of the two surfaces:
is on the first section at an applied torque which is lower than a breaking torque of the breaking torque wrench;
is aligned with the discontinuity in gradient at the breaking torque; and
is on the second section after the breaking torque wrench has reached the breaking torque, such that the two surfaces remain in contact after the breaking torque has been reached, causing a controlled break of the breaking torque wrench.

17. (canceled)

18. (canceled)
